(19) United States
(12) Patent Application Publication
(10) Pub. No.: US 2026/0326286 A1
(43) Pub. Date: Oct. 22, 2026

(54) Structure of the Inflatable Type, In Particular for a Robotic Arm

(71) Applicant: Politecnico Di Torino, Torino (TO) (IT)

(72) Inventors: Matteo Gaidano, Torino (IT); Stefano Mauro, Torino (IT); Matteo Melchiorre, Citta Sant'Angelo (IT); Pierpaolo Palmieri, Sammichele di Bari (IT); Laura Salamina, Barletta (IT); Mario Troise, Scafati (IT)

(21) Appl. No.: 19/491,083

(22) PCT Filed: Jun. 7, 2024
(86) PCT No.: PCT/IB2024/055590

§ 371 Date: Dec. 8, 2025

(30) Foreign Application Priority Data
Jun. 13, 2023 (IT) 102023000012117

(51) Int. Cl. B25J 9/14; B25J 18/06

(52) U.S. Cl. CPC B25J 9/142; B25J 18/06

(57) ABSTRACT

A structure of the inflatable type includes an external enclosure which forms or encloses at least one fluid-tight chamber, wherein the chamber is inflated with a fluid by a generator or accumulator, wherein the structure has a first end having a first cap and a second end having a second cap. A guide member is constrained to the first cap and to the second cap and is configured to extend and retract along a longitudinal axis of the guide member to allow the second cap and/or the first cap to make a movement along a direction substantially parallel to the longitudinal axis both during a phase of deploying or inflating the structure and during a phase of retracting or deflating the structure. A return system returns the second cap towards the first cap during a phase of retracting or deflating the at least one structure.

### BACKGROUND OF THE DISCLOSURE

### 1. The Field of the Disclosure

The present invention relates to a structure of the inflatable type according to the preamble of claim 1, which can be used for, in particular, creating a robotic arm of the inflatable type for space applications (i.e., for use in environments with low or zero gravity), and which represents a low-volume, low-weight, easier-to-transport alternative to traditional rigid structures. By way of example, a robotic arm made with structures of the inflatable type according to the present invention can be used for operations outside a spacecraft, e.g., maintenance, docking or debris capturing operations, or for operations inside the spacecraft, e.g., astronaut tasks or experiments.

It is however clear that the structure of the inflatable type of the present invention can also be used for terrestrial applications, and particularly wherever it may be useful to have available a structure which can be easily transported (due to its low weight and volume when deflated or packed) and which can be easily deployed to make it operational and then re-packed for transporting it again.

### 2. The Relevant Technology

Several technologies are currently known in the art which allow a structure of the inflatable type to extend in space after having been transported in a deflated or packed configuration.

The structures of the inflatable type known in the art can be folded by using various techniques, each one resulting in a different degree of stability during inflation. In general, no phase is envisaged during which such structures can be returned into the packed configuration. For this reason, once deployed, such structures are stiffened by means of various methods, e.g., using thermo-hardening resins or hard-setting foams. It is clear, therefore, that after using such methods the structure cannot be returned into a deflated or packed configuration.

Applications that make use of structures of the inflatable type are conceived in such a way to comprise very slender booms, typically dedicated to supporting solar panels, satellite return modules, or inflatable antennas; in this respect, inflatable environments can also be created, for example capable of accommodating astronauts on space stations.

For example, tests were conducted in recent times on the BEAM (“Bigelow Expandable Activity Module”) system, on the International space station, and on the LIFE (“Large Integrated Flexible Environment”) system.

### SUMMARY OF THE DISCLOSURE

In this frame, it is the main object of the present invention to provide a structure of the inflatable type so conceived as to overcome the drawbacks of prior-art inflatable structures.

It is therefore one object of the present invention to provide a structure of the inflatable type which ensures control and stability both during the deployment or inflation phase and during the retraction or packing or deflation phase.

It is another object of the present invention to provide a structure of the inflatable type which can guarantee that the deployment and retraction phases can be repeated multiple times, always with the same high quality.

It is another object of the present invention to provide a structure of the inflatable type, in particular for creating a low-inertia robotic arm of the inflatable type, so conceived as to allow the use of small, light motors and reduce the total weight of the structure.

It is a further object of the present invention to provide a structure of the inflatable type, in particular for creating a robotic arm of the inflatable type for space applications or for use in space, which can significantly cut the transportation costs to be incurred for delivering the structure to the intended site of use.

It is a further object of the present invention to provide a structure of the inflatable type for creating a robotic arm of the inflatable type which is relatively light and compact when transported in the deflated state, and which, when inflated, offers substantially the same functionality as a conventional manipulator arm of the rigid type.

It is yet another object of the present invention to provide a structure of the inflatable type which can provide a payload-to-weight ratio allowing considerable cost savings, in particular for space applications.

### BRIEF DESCRIPTION OF THE DRAWINGS

Further objects, features and advantages of the present invention will become apparent in light of the following detailed description and of the annexed drawings, which are provided herein merely by way of non-limiting explanatory example, wherein:

FIG. 1 is a perspective view of a structure of the inflatable type according to the present invention;

FIG. 2 is a perspective view of a component of the structure of the inflatable type according to the present invention;

FIG. 3 is a perspective view of an inflatable robotic arm, in particular for space applications, comprising at least one structure of the inflatable type according to the present invention.

### DETAILED DESCRIPTION OF THE PREFERRED EMBODIMENTS

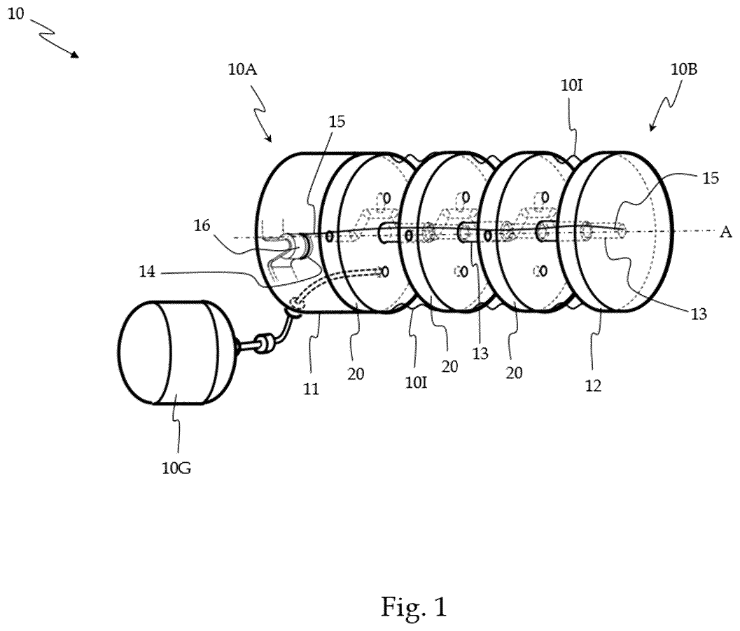

Referring now to the annexed drawings, in FIG. 1 reference numeral 10 designates as a whole a structure of the inflatable type according to the present invention; note that the structure 10 is shown in FIG. 1 in an inflated (or “deployed”) condition.

Said structure 10, in particular having a substantially cylindrical shape, comprises an external enclosure 10I which forms or encloses at least one fluid-tight chamber, wherein said chamber is inflated with a fluid, e.g., a gas or a liquid, by a generator or accumulator 10G.

In particular, said external enclosure 10I is made of a thin-film material comprising, for example, a multilayer, high-strength, low-weight material like kevlar, carbon fibre, nylon, etc. and a coating or an additional layer made of an elastomer, like rubber, to make the material fluid-tight. It must be pointed out that, together with said fluid, self-repairing materials may be used, for example like those used in self-sealing gas tanks, in order to give said thin-film material the ability to repair small punctures.

As far as said generator or accumulator 10G is concerned, in the embodiment shown in FIG. 1 it consists of a tank or a cylinder, in particular a high-pressure one (e.g., approx. 300 bar), thus being very compact; it is however clear that the generator or accumulator 10G may be of a different type as well.

Said structure 10 has a first end 10A comprising a first cap 11, and a second end 10B comprising a second cap 12. Preferably, said first cap 11 and second cap 12 are made of rigid material, for example plastic, aluminium, carbon fibre, or the like; moreover, they may be either positioned inside the external enclosure 10I or be so constructed that each one of them forms a respective portion of said external enclosure 10I.

In accordance with the present invention, said structure 10 comprises a guide member 13 constrained to said first cap 11 and to said second cap 12, said guide member 13 being configured to extend and retract along a longitudinal axis A (drawn with a dashed-dotted line in FIG. 1) of said guide member 13, which substantially coincides with a longitudinal axis of said structure 10 (the longitudinal axis of which is not shown in FIG. 1), to allow the second cap 12 and/or the first cap 11 to make a movement along a direction substantially parallel to said longitudinal axis A both during a phase of deploying (or inflating) said structure 10 and during a phase of retracting (or deflating) said structure 10.

In this regard, it should be noted that the guide member 13 is constrained to said first cap 11 and to said second cap 12 either by fastening means (which are known in the art and not shown in the accompanying drawings) or by forming the end portions of the guide member 13 integrally with, respectively, the first cap 11 and the second cap 12.

In a preferred embodiment, said guide member 13 comprises a telescopic rod, wherein the terminal tracts or ends of said telescopic rod are constrained to, respectively, said first cap 11 and said second cap 12.

Preferably, said telescopic rod is so constructed as to comprise at least one anti-rotation element configured to prevent any mutual rotational movement of said first cap 11 and second cap 12. In particular, said at least one anti-rotation element may comprise at least one element configured to prevent any rotational movement of the tracts that make up said telescopic rod; alternatively or additionally, said at least one anti-rotation element may comprise at least one element configured to prevent any rotational movement of the terminal tracts of the telescopic rod and of said first cap 11 and second cap 12, to which said terminal tracts are constrained.

In accordance with the present invention, said structure 10 also comprises a return system 14, 15, 16 configured to return the second cap 12 towards the first cap 11 during a phase of retracting (or deflating) said structure 10.

In one embodiment, said return system comprises:
a reel 14 associated with the first cap 11;
a cable 15, the ends of which are constrained to, respectively, the second cap 12 and the reel 14;
an actuating element 16 associated with the reel 14 in such a way as to rotate it in order to wind thereon at least part of the cable 15 during a phase of retracting (or deflating) said structure 10.

Preferably, said cable 15 runs through the guide member 13 or telescopic rod; furthermore, said actuating element 16 may comprise a motor, in particular of the electric type.

In this regard, it must be pointed out that said motor 16 is preferably configured to exert no drag torque during the phase of deploying (or inflating) said structure 10.

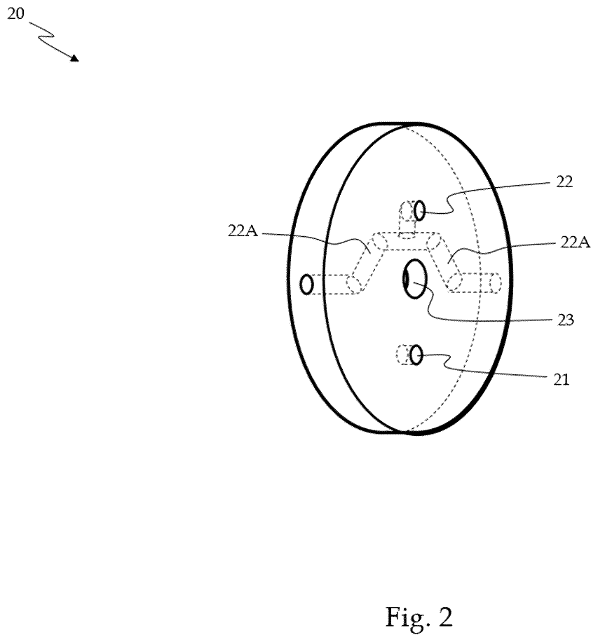

In accordance with the present invention, said structure 10 may comprise, for the purpose of ensuring control over deployment (or inflation) and retraction (or deflation) even when its length far exceeds its diameter, at least one separator element 20 (also shown in FIG. 2) configured to divide the fluid-tight chamber formed by the external enclosure 10I into a plurality of tight sub-chambers or sub-cells; for example, said structure 10 may comprise a number of separator elements 20 suitable for obtaining a length of each sub-chamber equal to approximately 250 mm, said length being, in particular, measured in a direction substantially parallel to the development of the guide member 13.

As can be observed in FIG. 2, said at least one separator element 20 comprises at least one valve 21, 22 to allow inflating (and hence deploying) and deflating (and hence retracting) the fluid-tight chamber formed by the external enclosure 10I of the structure 10, in particular to allow inflating and deflating each sub-chamber defined by said at least one separator element 20.

In accordance with one embodiment, said at least one valve 21, 22 may comprise a two-way valve to allow inflating (from a remote pressure source consisting of said generator or accumulator 10G) and deflating the structure 10.

In a preferred embodiment (like the one shown in the accompanying drawings), said at least one valve 21, 22 comprises:
a first valve 21 connected to said generator or accumulator 10G for inflating the structure 10;
a second valve 22 for deflating the structure 10, in particular said second valve 22 being connected to at least one channel 22A (drawn in FIG. 2 with dashed lines to indicate that said at least one channel 22A is preferably formed in the body of the separator element 20) for draining the fluid out of the external enclosure 10I of the structure 10.

In all of the above-described embodiments, said at least one valve 21, 22 is preferably an electrically controlled and normally closed on-off valve; with such a type of valve 21, 22, no power is consumed when the structure 10 of the inflatable type is in an operating condition, i.e., during all phases other than inflation and deflation. In this respect, it must be pointed out that said at least one valve 21, 22 is preferably connected to a control line of the structure 10, wherein said control line is configured to send control signals to said at least one valve 21, 22 and to the generator or accumulator 10G in order to control the inflation and deflation of said structure 10.

FIG. 2 also shows that said at least one separator element 20 preferably comprises a through hole 23 configured to allow the guide member 13 to pass therethrough. In this regard, it must be pointed out that, in one embodiment wherein said guide member 13 consists of a telescopic rod and wherein the structure 10 comprises a plurality of separator elements 20 (as shown by way of example in FIG. 1), the through hole 23 of each separator element 20 is so sized as to allow the passage of a corresponding tract of said telescopic rod.

Preferably, said at least one separator element 20 has a substantially discoid shape, wherein said through hole 23 is situated substantially in the centre of the separator element 20; in this case, preferably said separator element 20 is positioned within the fluid-tight chamber formed by the external enclosure 10I of the structure 10 in such a way that said through hole 13 develops along the longitudinal axis of said structure 10 (which in turn substantially coincides with the longitudinal axis A of the guide member 13).

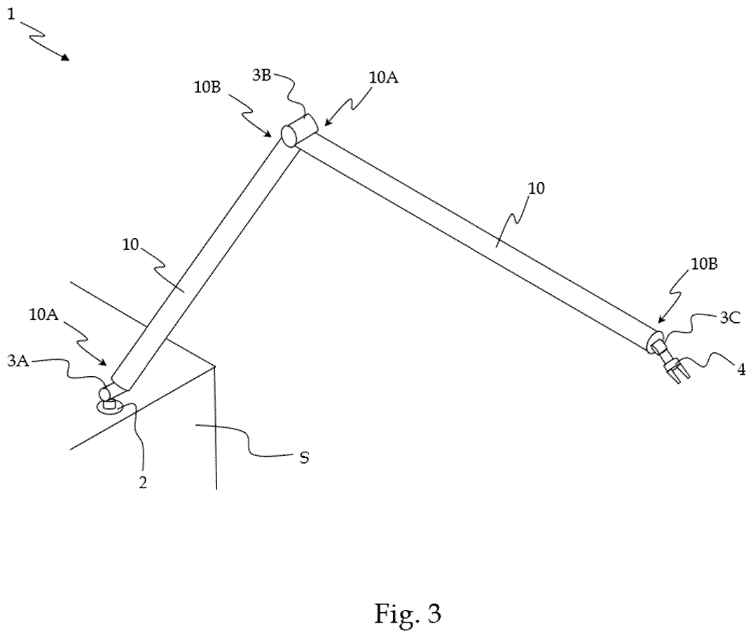

FIG. 3 shows a robotic arm of the inflatable type (designated as a whole by reference numeral 1), in particular for space applications or for use in space, which comprises at least one structure 10 according to the present invention.

In this respect, the structure 10 is substantially cylindrical in shape and has a length of, for example, approximately one metre; it must be noticed that the dimensions of the structure 10 may nevertheless vary, particularly as a function of the specific tasks that the arm 1 will have to carry out.

In particular, in the embodiment shown in FIG. 3 the arm 1 comprises two structures 10, wherein a first structure 10 is connected to a base 2 (which in turn can be connected or secured to a surface S), in particular by means of a first articulated joint 3A, and wherein said structures 10 are connected to each other by means of a second articulated joint 3B; it must nevertheless be pointed out that, in accordance with the present invention, the arm 1 may comprise any number of structures 10 (or even just one structure 10).

The arm 1 may then comprise a tool 4 connected to a distal end of a terminal structure 10, preferably by means of a further articulated joint 3C. In this respect, the definition of the structure 10 to which the tool 4 is connected as “terminal” means that such structure 10 is the distal structure of the arm 1; therefore, it can be stated that said tool 4 is connected to a distal end of the arm 1.

In the embodiment shown in FIG. 3, said tool 4 consists of a gripping or clamping unit, in particular a motorized one; it is however clear that said tool 4 may also be of a different kind.

The arm 1 also comprises at least one control line (not shown in the annexed drawings), in particular of the electric type, which connects the base 2 with said articulated joints 3A, 3B, 3C and/or with the tool 4, wherein said at least one control line is configured to carry control signals from the base 2 to the articulated joints 3A, 3B, 3C and/or to the tool 4 in order to control the actuation and movements of said at least one structure 10 and/or of the tool 4. Said at least one control line may be situated within said at least one structure 10 (i.e., within each structure 10, when the arm 1 comprises a plurality of structures 10); alternatively, said at least one control line may be provided outside or on the surface of said at least one structure 10 (i.e., outside or on the surface of each structure 10, when the arm 1 comprises a plurality of structures 10).

As far as the articulated joints 3A, 3B, 3C are concerned, they are so constructed as to allow each structure 10 and/or the tool 4 to move about at least one axis of rotation.

Preferably, said control line is of the electric type and is configured to allow the components of the arm 1 to be electrically actuated; in this regard, an electric actuation is advantageous over a pneumatic actuation because it permits the use of a control system which is less complex than the one employed for pneumatically actuated inflatable manipulators, resulting in easier power management and motion control if confronted with a pneumatic actuation.

The features of the structure 10 of the inflatable type according to the present invention, as well as the advantages thereof, are apparent from the above description.

Indeed, the provisions of the present invention make it possible to overcome the drawbacks of prior-art inflatable structures by providing a structure 10 of the inflatable type, in particular to be used for creating an inflatable robotic arm 1, wherein said structure 10 has been so conceived as to include a guide member 13 and a return system 14, 15, 16 that ensure controllability and stability of said inflatable structure 10 both during the deployment or inflation phase and during the retraction or packing (or deflation) phase.

It is therefore clear that the provisions of the present invention make it possible to provide a structure 10 of the inflatable type, in particular to be used for creating an inflatable robotic arm 1, which can guarantee that the deployment and retraction phases can be repeated multiple times, always with the same high quality.

Moreover, the pneumatic system employed for inflating the structure 10 according to the present invention is smaller and simpler than, in particular, the one of pneumatically actuated inflatable manipulators according to the prior art.

The reduced inertia of the robotic arm 1 according to the present invention leads to lower power consumption; in this respect, the electric actuation of the robotic arm 1 according to the present invention permits the use of a control system which is less complex than the one employed in pneumatically actuated inflatable manipulators according to the prior art, resulting in further advantages in terms of total weight and volume of the whole system comprising the robotic arm 1 and the control system.

In this regard, the pneumatic system of the robotic arm 1 according to the present invention does not need much energy to operate, also because it is not used during the operating phases of the robotic arm 1 (i.e., in all conditions other than inflation and deflation) and is preferably supplied by a generator or accumulator 10G consisting of a very compact high-pressure tank.

It is therefore apparent that the provisions of the present invention make it possible to create a structure 10 (as well as a robotic arm 1 comprising at least one structure 10 according to the present invention) which is both light and compact when transported in a deflated state, and which can provide the same functionality as a conventional rigid manipulator arm when inflated.

In addition to this, the structure 10 and the robotic arm 1 according to the present invention are such as to offer a payload-to-weight ratio that results in considerable cost savings.

The structure 10 and the robotic arm 1 described herein by way of example may be subject to many possible variations without departing from the novelty spirit of the inventive idea, and it is also clear that in the practical implementation of the invention the illustrated details may have different shapes or be replaced with other technically equivalent elements.

It can therefore be easily understood that the present invention is not limited to the above-described structure 10 and robotic arm 1, but may be subject to many modifications, improvements or replacements of equivalent parts and elements without departing from the inventive idea, as clearly specified in the following claims.

By way of example, it is worth mentioning that the return system according to the present invention may be designed to comprise actuator means (not shown in the embodiments illustrated in the accompanying drawings) configured to act directly upon the guide member 13 to allow said guide member 13 to contract or retract.

1. A structure of the inflatable type, in particular having a substantially cylindrical shape, comprising an external enclosure which forms or encloses at least one fluid-tight chamber, wherein said chamber is inflated with a fluid by a generator or accumulator,
wherein said structure has a first end comprising a first cap and a second end comprising a second cap,
said structure being comprised of the following:
a guide member constrained to said first cap and to said second cap, wherein the guide member is configured to extend and retract along a longitudinal axis (A) of said guide member, which substantially coincides with a longitudinal axis of said structure, to allow the second cap and/or the first cap to make a movement along a direction substantially parallel to said longitudinal axis (A) both during a phase of deploying or inflating said structure and during a phase of retracting or deflating said structure;
a return system configured to return the second cap towards the first cap during a phase of retracting or deflating said at least one structure.

2. The structure according to claim 1, wherein said guide member comprises a telescopic rod, wherein the terminal tracts or ends of said telescopic rod are constrained to, respectively, said first cap and said second cap.

3. The structure according to claim 2, wherein said telescopic rod is so constructed as to comprise at least one anti-rotation element configured to prevent any mutual rotational movement of said first cap and second cap.

4. The structure according to claim 1, wherein said return system comprises:
a reel associated with the first cap;
a cable, the ends of which are constrained to, respectively, the second cap and the reel;
an actuating element associated with the reel in such a way as to rotate it in order to wind thereon at least part of the cable during a phase of retracting or deflating said at least one structure.

5. The structure according to claim 4, wherein said cable runs through the guide member.

6. The structure according to claim 1, further comprising at least one separator element configured to divide the fluid-tight chamber formed by the external enclosure into a plurality of tight sub-chambers or sub-cells.

7. The structure according to claim 6, wherein said at least one separator element comprises at least one valve to allow inflating and deflating the fluid-tight chamber formed by the external enclosure of the structure, in particular to allow inflating and deflating each sub-chamber defined by said at least one separator element.

8. The structure according to claim 7, wherein said at least one valve comprises a two-way valve.

9. The structure according to claim 7, wherein said at least one valve comprises:
a first valve connected to said generator or accumulator for inflating the structure;
a second valve for deflating the structure, in particular said second valve being connected to at least one channel for draining the fluid out of the external enclosure of the structure.

10. The structure according to claim 7, wherein said at least one valve is an electrically controlled and normally closed on-off valve.

11. The structure according to claim 6, wherein said at least one separator element comprises a through hole configured to allow the guide member to pass therethrough.

12. The structure according to claim 6, wherein said at least one separator element has a substantially discoid shape, wherein said through hole is situated substantially in the centre of the separator element.

13. The structure according to claim 12, wherein said separator element is positioned within the fluid-tight chamber formed by the external enclosure of the structure in such a way that said through hole is located at the longitudinal axis of said structure.

14. The structure according to claim 13, further comprising an electric control line configured to allow the components of said structure to be electrically actuated.

15. A robotic arm of the inflatable type, in particular for space applications, comprising at least one structure of the inflatable type according to claim 1.
